(19) United States
(12) Patent Application Publication
(10) Pub. No.: US 2018/0026465 A1
(43) Pub. Date: Jan. 25, 2018

(54) ELECTRICAL POWER SUPPLY MODULE, IN PARTICULAR FOR AN AIRCRAFT

(71) Applicant: Zodiac Aero Electric, Montreuil (FR)

(72) Inventor: Fabrice Guerin, Montreuil (FR)

(73) Assignee: Zodiac Aero Electric, Montreuil (FR)

(21) Appl. No.: 15/638,004

(22) Filed: Jun. 29, 2017

(30) Foreign Application Priority Data
Jul. 20, 2016 (FR) 1656893

(51) Int. Cl. H02J 7/00; H02B 1/46; B64D 47/00; H02B 1/20

(52) U.S. Cl. CPC H02J 7/0063; H02B 1/20; H02B 1/46; B64D 47/00; B64D 2221/00

(57) ABSTRACT

An electrical power supply module intended to supply power to an on-board DC electrical network of an aircraft comprising a battery (12) including a primary line (16), a secondary line (18) and a switching member between said primary and secondary lines; and an electrical distribution box (24) separate from the battery (12) including at least one electrical power supply busbar (26) and a plurality of electrical distribution lines (28) each bearing a circuit breaker (30). The power supply module comprises a connection pad (32) positioned on the secondary power supply line (18) allowing a voltage connection between the battery (12) and the electrical distribution box (24).

The invention relates, in general, to the supply of power to the on-board DC electrical network of an aircraft.

More particularly, the invention relates to assemblies of energy storage elements, also called energy accumulators or batteries, and power supply devices.

The DC electrical network of aircraft, and in particular of commercial aircraft, is intended to supply power to loads of various natures such as, for example, procedures executed on the ground or in emergency mode or else certain items of electronic equipment on the instrument panel. Most current aircraft use lead or nickel-cadmium batteries to supply power to this DC electrical network and require power to be supplied continuously to certain loads, without however powering up the aircraft.

In order to supply power continuously to certain loads, the power supply busbar, referred to as the “hot bus”, of the electrical network is thus connected directly to the voltage output of the battery.

However, there is a need to provide a greater supply of energy on board aircraft.

It would therefore be advantageous to exchange the current batteries for batteries of lithium-ion type. However, owing to the different structure of batteries of lithium-ion type with respect to the structure of the current batteries, implementing such batteries of lithium-ion type requires modifications.

Thus, such batteries incorporate a switching member in order to power down or power up its power supply outputs.

In light of the above, the aim of the invention is to propose an electrical power supply module incorporating a battery, in particular of lithium-ion type.

A subject of the invention is therefore an electrical power supply module intended to supply power to an on-board DC electrical network of an aircraft comprising a battery comprising a primary line, a secondary line and a switching member between said primary and secondary lines; and an electrical distribution box separate from the battery including at least one electrical power supply busbar and a plurality of electrical distribution lines each bearing a circuit breaker.

The electrical power supply module comprises a connection pad positioned on the secondary power supply line allowing the voltage connection between the battery and the electrical distribution box.

Thus, a modular assembly is obtained combining a battery and a panel bearing circuit breakers and/or switching members.

Preferably, the battery is of the lithium-ion type.

Advantageously, the electrical power supply module comprises means for fastening the electrical distribution box to a lateral face of the battery allowing the electrical distribution box to be mechanically fastened to the battery.

Thus, the electrical distribution box interfaces with the battery only through the voltage supply and the fastening means.

Preferably, the fastening means are reversible mechanical fastening means, so as to allow the battery or the electrical distribution box to be replaced or repaired independently of the other.

In one embodiment, the fastening means are screws, nuts and bolts or quarter-turn fasteners, for example four thereof, each positioned at a corner of said lateral face of the battery.

In one embodiment, the fastening means comprise hinges, positioned respectively on one side of said lateral face of the battery in order to allow the electrical distribution box to be articulated with respect to the battery.

The connection pad is, for example, inserted into a through-hole made in said lateral face of the body of the battery.

Preferably, the pad is a high-power pad.

Advantageously, the electrical distribution box takes the form of a parallelepipedal panel, the height and/or width of which are substantially identical to the height and/or width of the battery, respectively. Thus, when the electrical distribution box is fastened to the battery, the assembly forms an electrical power supply module taking the general form of a parallelepiped of uniform size.

Other objects, features and advantages of the invention will become apparent on reading the following description, which is given solely by way of non-limiting example and with reference to the appended drawings, in which:

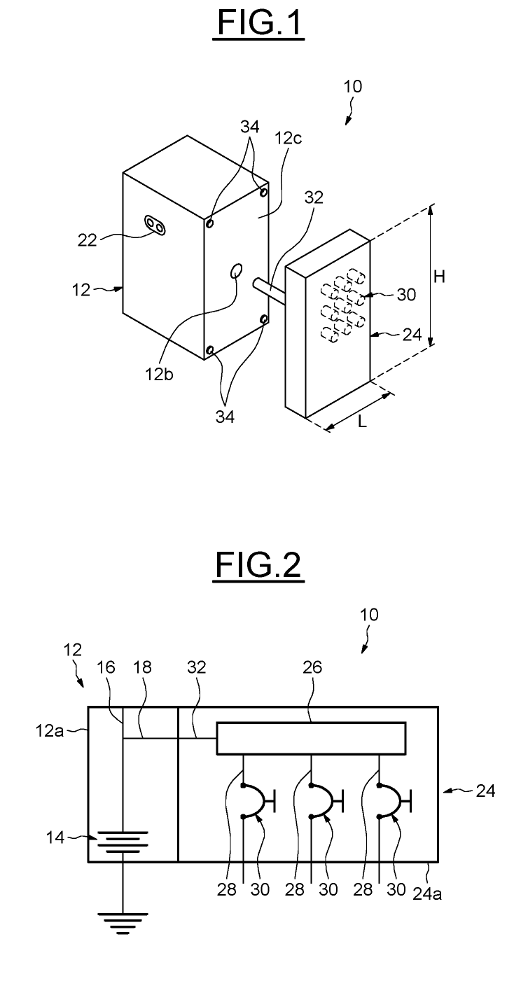

FIG. 1 shows a power supply module according to one embodiment of the invention; and

FIG. 2 schematically shows the internal architecture of the power supply module of FIG. 1.

FIG. 1 shows an electrical power supply module, referenced 10 in its entirety, intended to supply power to an on-board DC electrical network of an aircraft.

As illustrated, the electrical power supply module 10 comprises an assembly of electrical energy accumulators, or battery, 12, for example of lithium-ion type, allowing chemical energy to be converted to electrical energy by virtue of a redox chemical reaction. The lithium-ion battery 12 comprises a body 12a enclosing a plurality of modules 14 grouping together a group of accumulators (not shown) connected in parallel and/or in series, a primary power supply line 16 and a secondary power supply line 18. The lithium-ion battery 12 also comprises a switching member (not shown) positioned on the secondary power supply line 18 and output terminals 22 connected to the primary power supply line 16.

Batteries of lithium-ion type are known and will not be described further in the remainder of the description.

The electrical power supply module 10 additionally comprises an electrical distribution box 24 including a body 24a inside which an electrical power supply busbar, or “hot bus”, 26 and a plurality of electrical distribution lines 28 are positioned, each line bearing a circuit breaker and/or a switching member 30 intended to supply power to a respective load.

A voltage connector or connection pad 32 positioned on the secondary power supply line 18 allows the voltage connection between the battery 12 and the electrical distribution box 24, and, more particularly, the electrical power supply busbar 26.

As illustrated in FIG. 1, the connection pad 32 is inserted into a through-hole 12b made in one of the lateral faces 12c of the body 12a of the battery 12.

The electrical power supply module 10 additionally comprises fastening means 34 allowing the electrical distribution box 24 to be mechanically fastened to the lithium-ion battery 12 and, more specifically, to the lateral face 12c incorporating the hole 12b for accommodating the connection pad 32.

As illustrated, the fastening means 34 are, for example, screw-fastening means, for example four thereof, each positioned at a corner of a lateral face 12c of the battery. Provision may be made for the number of fastening means 34 to be different and for them to be arranged differently. The fastening means may interact with a structure of hinge type, positioned respectively on one side of said face of the battery in order to allow the electrical distribution box 24 to be articulated with respect to the battery 12.

As illustrated and by way of non-limiting example, the electrical distribution box 24 takes the form of a parallelepipedal panel of height H and of width L. The height H and/or the width L may be substantially identical to the height and to the width of the battery 12, respectively. Thus, when the electrical distribution box 24 is fastened to the battery, the assembly forms an electrical power supply module 10 taking the general form of a parallelepiped of uniform size.

By virtue of the present invention, the electrical distribution box is mechanically combined with the battery, while keeping the battery and the electrical distribution box separate in order to keep management and configuration specific to these two separate elements.

Moreover, the power supply module according to the invention allows the electrical distribution box to be connected directly to the voltage of the battery.

The embodiments of the invention in which an exclusive property or privilege is claimed are defined as follows:

1. An electrical power supply module intended to supply power to an on-board DC electrical network of an aircraft comprising:
a battery including a primary line, a secondary line and a switching member positioned between said primary and secondary lines; and
an electrical distribution box separate from the battery including at least one electrical power supply busbar and a plurality of electrical distribution lines each bearing a circuit breaker;
characterized in that it comprises a connection pad positioned on the secondary power supply line allowing a voltage connection between the battery and the electrical distribution box.

2. The electrical power supply module according to claim 1, in which the battery is a battery of the lithium-ion type.

3. The electrical power supply module according to claim 1, comprising means for fastening the electrical distribution box to a lateral face of the battery.

4. The electrical power supply module according to claim 3, in which the fastening means are mechanical and reversible fastening means.

5. The electrical power supply module according to claim 4, in which the fastening means are screws, nuts, and bolts or quarter-turn fasteners.

6. The electrical power supply module according to claim 3, in which the fastening means comprise hinges positioned respectively on one side of said lateral face of the battery.

7. The electrical power supply module according to claim 3, in which the connection pad is inserted into a through-hole made in said lateral face of the body of the battery.

8. The electrical power supply module according to claim 1, in which the connection pad is a high-power pad.

9. The electrical power supply module according to claim 1, in which the electrical distribution box takes the form of a parallelepipedal panel, the height (H) and/or width (L) of which are substantially identical to the height and/or width of the battery, respectively.

10. The electrical power supply module according to claim 1, in which the battery comprises output terminals connected to the primary power supply line.
